(19) United States
(12) Patent Application Publication
(10) Pub. No.: US 2025/0192588 A1
(43) Pub. Date: Jun. 12, 2025

(54) POWER SUPPLY METHOD OF VEHICLE IMAGE RECORDING APPARATUS BASED ON REDUNDANCY POWER CONVERSION AND SYSTEM FOR THE SAME

(71) Applicants: Hyundai Motor Company, Seoul (KR); Kia Corporation, Seoul (KR)

(72) Inventors: Jae Ho Choi, Hwaseong-si (KR); Byung Yoon Choi, Hwaseong-si (KR); Soon Cheol Hwang, Hwaseong-si (KR)

(21) Appl. No.: 18/933,522

(22) Filed: Oct. 31, 2024

(30) Foreign Application Priority Data
Dec. 6, 2023 (KR) 10-2023-0175390

(51) Int. Cl. H02J 7/00; B60R 16/033; H01M 10/42; H01M 10/44; H01M 10/46; H02J 9/06

(52) U.S. Cl. CPC H02J 7/0063; B60R 16/033; H01M 10/425; H01M 10/44; H01M 10/46; H02J 9/06; H01M 2220/20; H02J 2207/20

(57) ABSTRACT

A method for supplying power of a vehicle image recording apparatus (IRA) based on redundancy power conversion can include determining whether a park low battery module (PLBM) of the IRA is in a normal state in a parked state, detecting a voltage state of the first low-voltage battery or the second low-voltage battery when it is determined that the PLBM is in an abnormal state, determining whether the detected voltage state of the first low-voltage battery is usable as a replacement for the PLBM, and supplying discharge power of the first low-voltage battery as driving power of the IRA when it is determined that the first low-voltage battery is usable as the replacement for the PLBM, and a system for the same.

### CROSS-REFERENCE TO RELATED APPLICATIONS

This application claims the benefit of Korean Patent Application No. 10-2023-0175390, filed on Dec. 6, 2023, which application is hereby incorporated herein by reference.

### TECHNICAL FIELD

The present disclosure relates to a power supply of a vehicle image recording apparatus.

### BACKGROUND

In an automotive-related industry, a demand for improving a fuel economy has been continuously issued due to vehicle environmental requirements and high fuel prices, and various researches and developments are being performed according to above-described paradigm changes. In recent years, various types of researches and developments for improving the fuel economy are being performed in response to strengthened fuel economy regulations for vehicle companies, such as corporate average fuel economy (CAFE). As a part of this technological development, vehicle developments such as a battery EV and a Hybrid EV that use electrical energy are being actively examined.

In particular, a business for building infrastructure for commercialization of intelligent vehicles and expansion of an autonomous vehicle market cause a continuous investment on autonomous vehicles even in a domestic market. The autonomous vehicles that are capable of autonomously monitoring external information and recognizing a road condition to autonomously drive to a set destination even without an operation of a driver require additional power for various sensors and computing systems compared to general vehicles.

That is, because the autonomous vehicle is operated with a sensor, an internal MCU, and a steering system without intervention of the driver, a problem occurring in internal power may lead to a major accident due to lack of power of various sensors, steering systems, or brakes.

A power generation system in a typical autonomous vehicle may generate a short circuit or disconnection in a power system due to an internal defect or an external factor while the autonomous vehicle is driving, thereby generating a problem such that the vehicle stops while driving.

To solve the above-described problem, an autonomous vehicle system realizes a redundancy technology that has dual ECUs and dual power supply devices for emergency driving to a destination without the intervention of the driver although a failure occurs.

The above-described redundancy technology is being developed in various types according to characteristics for each vehicle manufacturing company. Among the various types, a manufacturing company that uses both a first operating voltage 24V and a second operating voltage 12V has a redundancy architecture as illustrated in FIG. 1.

FIG. 1 shows a high voltage junction box 10 (hereinafter, referred to as HV J/BOX) for distributing a high voltage supplied from a main battery (not shown).

Also, FIG. 1 shows power conversion controllers that convert the high voltages supplied from the HV J/BOX 10 into low voltages. A first low DC-DC converter (LDC) 21 converts the high voltage into a low voltage of 12V and outputs the converted low voltage, and the second LDC 22 converts the high voltage into a low voltage of 24V and outputs the converted low voltage.

FIG. 1 shows active junction block (AJB) 31, 32, each including a back to back switch (B2B) (no reference number). The B2B represents a switch having a function of detecting and blocking a power fail. The first AJB 31 is dedicated to 12V, and the second AJB 32 is dedicated to 24V.

FIG. 1 shows a redundancy power converter (RPC) 40 that is a bidirectional power conversion controller for 12V and 24V.

FIG. 1 shows sub-battery modules (SBM) 51, 52, each including a low-voltage battery and an intelligent battery sensor (IBS) that detects a state of the low-voltage battery. The first SBM 51 is dedicated to 12V, and the second SBM 52 is dedicated to 24V.

FIG. 1 shows a power-net domain controller (PDC) 60 that distributes introduced 12V or 24V power to electrical loads 81, 82.

FIG. 1 shows loads 71, 72 (e.g., a brake, a control unit, a steering wheel, etc.) related to an operation of a vehicle.

As illustrated in FIG. 1, a power system can be capable of simultaneously supplying 12V and 24V power to a low-voltage power network of a commercial vehicle. When a general power (expressed by a solid line) is diagnosed as a failure state by a function for each component, the power system blocks supply of failure power and provide redundancy power.

When a second LDC 22 malfunctions or fails to provide a normal supply of 24V, the second AJB 32 requests a conversion signal to the RPC 40 through a local communication network in the vehicle as illustrated in FIG. 1. The conversion request signal in FIG. 1 illustrates only a signal line requested from the second AJB 32 for convenience of description.

Accordingly, the RPC 40 converts the 12V power supplied through the first AJB 31 into the 24V power and supplies the converted 24V power to the second AJB 32, and the second AJB 32 supplies the 24V power supplied from the RPC 40 components connected downstream thereof, such as load 72, second SBM 52, and PDC 60.

Referring to only a configuration of supplying power to a vehicle image recording apparatus in the power supply system having the above-described redundancy architecture in FIG. 2, an image recording apparatus (IRA) receives driving power through a power line PL1 of the PDC 60 while the vehicle is driving and receives driving power through a power line PL2 of a park low battery module (PLBM) while the vehicle is parked.

Also, the PLBM is recharged by the PDC 60 while the vehicle is driving.

When the PLBM is damaged or completely discharged due to a long-term parking, the IRA may not be driven to record events occurring while the vehicle is parked.

### SUMMARY

An embodiment of the present disclosure can solve the above-described problems. The present disclosure relates to a power supply of a vehicle image recording apparatus, and more particularly, to a power supply method of a vehicle image recording apparatus based on redundancy power conversion for stably driving the vehicle image recording apparatus through power supply based on redundancy power conversion in a parking mode condition even under an environment in which a park low battery module of the vehicle image recording apparatus is failed or completely discharged, and a system for the same.

An embodiment of the present disclosure can provide a power supply method of a vehicle image recording apparatus based on redundancy power conversion, and a system for the same. An embodiment of the present disclosure can provide a vehicle image recording apparatus that can be stably driven through power supply based on redundancy power conversion in a parking mode condition even under an environment in which a park low battery module of the vehicle image recording apparatus has failed or completely discharged.

In an embodiment of the present disclosure, a method for supplying power of an image recording apparatus for a vehicle can include determining whether a battery module of the image recording apparatus (IRA) is in a normal state, detecting a voltage state of a first low-voltage battery or a second low-voltage battery when it is determined that the battery module is in an abnormal state, determining whether the first low-voltage battery is usable as a replacement for the battery module according to the detected voltage state, and supplying power of the first low-voltage battery to the IRA when it is determined that the first low-voltage battery is usable as the replacement for the battery module.

In an embodiment, a method may further include converting power of the second low-voltage battery into a first low voltage to provide to the IRA when it is determined that the first low-voltage battery is not usable as the replacement for the battery module.

In an embodiment, the determining of whether the first low-voltage battery is usable as a replacement for the battery module can include determining that the first low-voltage battery is not usable as the replacement when a charged state of the first low-voltage battery is below a preset threshold value, and the first low-voltage battery is situated in a case in which supplementary charging thereto is unavailable.

In an embodiment, the case in which the supplementary charging is unavailable can include a case in which supplementary charging for the first low-voltage battery is unavailable due to a failure or non-response of a controller related to the supplementary charging.

In an embodiment, the case in which the supplementary charging is unavailable can include a case in which the supplementary charging for the first low-voltage battery is unavailable because a wireless update on a control component of a high-voltage battery supplying power for the supplementary charging is in progress.

In an embodiment, the case in which the supplementary charging is unavailable can include a case in which the supplementary charging for the first low-voltage battery is unavailable due to a condition in which a state of charge (SOC) of a high-voltage battery supplying power for the supplementary charging is equal to or less than a preset level.

In an embodiment, the case in which the supplementary charging is unavailable can include a case in which the supplementary charging is unavailable because a maintenance operation is in progress.

In an embodiment, the case in which the supplementary charging is unavailable can include a case in which the supplementary charging is unavailable due to a condition in which an IG3 power mode is not applied in the vehicle, wherein the IG3 power mode is a power mode in which power is applied to at least one controller related to charging, by an external power source, a high-voltage battery that supplies for the supplementary charging.

In an embodiment, the first low-voltage battery may use a 12V low-voltage battery.

In an embodiment, the second low-voltage battery may use a 24V low-voltage battery.

In an embodiment of the present disclosure, a power supply system of an image recording apparatus for a vehicle can include: a first low DC-DC converter (LDC) that can convert a high voltage of a main battery into a first low voltage; a second LDC that can convert the high voltage of the main battery into a second low voltage; a first active junction block (AJB) including a built-in back to back switch (B2B), which can receive the first low voltage output from the first LDC and can supply the first low voltage to a first electrical load operating in the first low voltage; a second AJB including a built-in B2B, which can receive the second low voltage output from the second LDC and can supply the second low voltage to a second electrical load operating in the second low voltage; a first sub-battery module (SBM) including a first low-voltage battery that can be charged by the first low voltage supplied from the first AJB and can supply power to the first electric load and a first intelligent battery sensor (IBS) that detects a state of the first low-voltage battery; a second SBM including a second low-voltage battery that can be charged by the second low voltage supplied from the second AJB and can supply power to the second electric load and a second IBS that detects a state of the second low-voltage battery; a redundancy power converter (RPC) that can convert power between the first low voltage and the second low voltage according to a power conversion request signal generated by the first AJB or the second AJB; a battery module that can supply power to the IRA in a parked state of the vehicle; and a controller including a non-transitory memory storing instructions for controlling power supply to the IRA and a processor executing the instructions, where the controller can check a state of the battery module in the parked state, check a state of the first low-voltage battery through the first IBS when the state of the battery module is not in a normal state, and then supply power of the first low-voltage battery to the IRA when the first low-voltage battery is in the normal state.

In an embodiment, the controller can transmit a supplementary charging request signal when it is determined that supplementary charging is required by checking a state of the first low-voltage battery through the first IBS of the first SBM, and can request a formation of a path for supplementary charging of the first low-voltage battery to the RPC when a condition that the supplementary charging is unavailable is checked through a response to the supplementary charging request signal, and the RPC can form a power conversion path from the second SBM to the first SBM for the supplementary charging of the first low-voltage battery as requested by the PDC.

In an embodiment, the condition that the supplementary charging is unavailable can include a case in which the supplementary charging is unavailable due to a condition of failures or non-responses of a controller related to the supplementary charging.

In an embodiment, the condition that the supplementary charging is unavailable can include a case in which the supplementary charging is unavailable due to a condition in which a wireless update on a control component of the main battery is in progress.

In an embodiment, the condition that the supplementary charging is unavailable can include a case in which the supplementary charging is unavailable due to a condition in which a SOC of the main battery is equal to or less than a preset level.

In an embodiment, the condition that the supplementary charging is unavailable can include a case in which the supplementary charging is unavailable due to a condition in which a maintenance operation is in progress.

In an embodiment, the condition that the supplementary charging is unavailable can include a case in which the supplementary charging is unavailable due to a condition in which IG3 power mode is not applied in the vehicle, where the IG3 power mode is a power mode in which power is applied to at least one controller related to charging by an external power source a high-voltage battery that supplies for the supplementary charging.

In an embodiment, each of the PLBM and the first low-voltage battery may use a 12V low voltage battery.

In an embodiment, the second low-voltage battery may use a 24V low-voltage battery.

### BRIEF DESCRIPTION OF THE DRAWINGS

It can be understood that the appended drawings are not necessarily to scale, presenting a somewhat simplified representation of various features illustrative of example embodiments of the present disclosure. The specific design features of an embodiment of the present disclosure as included herein, including, for example, specific dimensions, orientations, locations, and shapes can be determined in part by the particularly intended application and use environment.

In the figures, same reference numerals can refer to same or equivalent parts of an example embodiment of the present disclosure throughout the several figures of the drawing.

FIG. 1 is a view illustrating an example of a typical redundancy architecture of a vehicle, in which electrical loads using 12V power and 24V power are mixed;

FIG. 2 is a view illustrating an example of a power supply system of a typical image recording apparatus applied according to FIG. 1;

FIGS. 3 and 4 are schematic views, each illustrating an example of a power transmission path in a power supply system of a vehicle image recording apparatus based on redundancy power conversion according to an embodiment of the present disclosure; and

FIG. 5 is a flowchart illustrating an example of a power supply process of the vehicle image recording apparatus based on the redundancy power conversion according to an embodiment of the present disclosure.

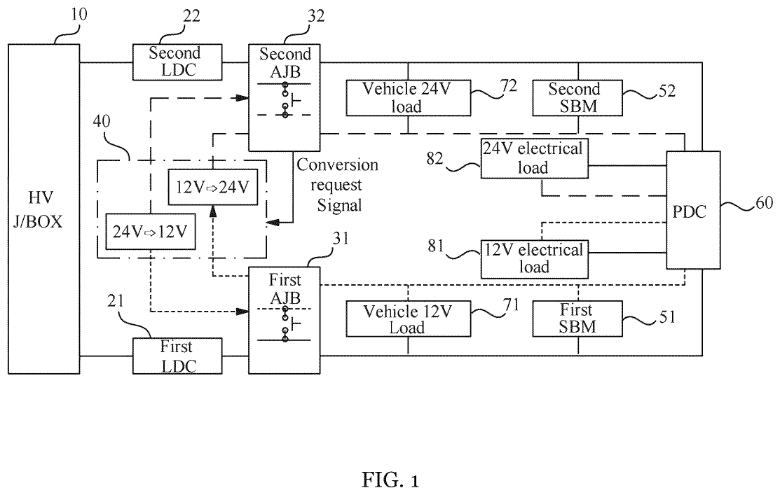

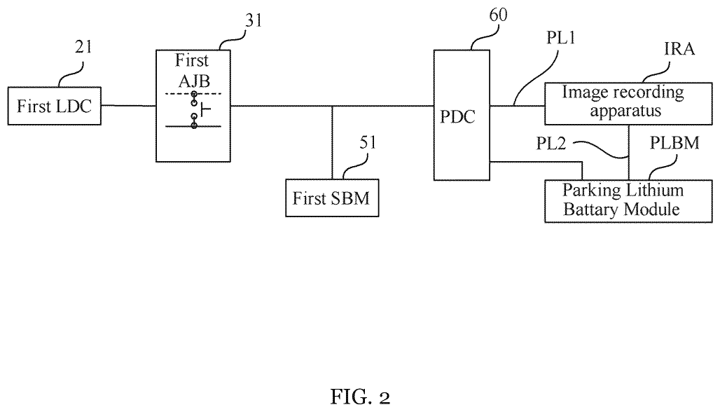

### DETAILED DESCRIPTION OF ILLUSTRATIVE EMBODIMENTS

Example embodiments are illustrated in the drawings and are described in the detailed description of the disclosure. However, such example embodiments do not necessarily limit the present disclosure and it can be understood that the present disclosure can cover modifications, equivalents, and replacements for other embodiments within the ideas and technical scopes of the present disclosure.

In this specification, the suffixes “module” and “unit” can be used merely for nominal distinction between components and not necessarily to be interpreted as implying that the components are physically or chemically separated or that they can be separated.

It can be understood that although the terms of “first” and “second” can be used herein to describe various elements, these elements are not necessarily limited by these terms. These terms can be used solely to differentiate one component from another in name, and their sequential meanings can be understood through the context of the description rather than by the names themselves.

The term “and/or” can be used to include all possible combinations of the listed items. For example, “A and/or B” can include all three cases of “A”, “B”, and “A and B”.

It also can be understood that when an element is referred to as being “connected to” or “engaged with” another element, it can be directly connected to the other element, or intervening elements may also be present.

In the following description, technical terms can be used only for explaining a specific example embodiment while not necessarily limiting the present disclosure. Terms of a singular form may include plural forms unless referred to the contrary. “Include” and “comprise” specify a property, a region, a fixed number, a step, a process, an element, and/or a component but do not exclude other properties, regions, fixed numbers, steps, processes, elements, and/or components.

Unless terms used in the present disclosure are defined differently, the terms may be construed with a meaning known to those skilled in the art. Terms such as terms that are generally used and have been in dictionaries can be construed as having meanings matched with contextual meanings in the art.

Also, the terms “unit,” “control unit,” “control device,” and “controller” can be widely used to name devices that control specific functions and do not refer to a generic functional unit. Also, the devices denoted by such names may include a communication device that communicates with another controller or sensor to control the corresponding function, a computer-readable recording medium that stores an operation system, a logic command, and input/output information, and at least one processor that performs determinations, decisions, and calculations required for function control, for example.

On the other hand, a processor may include semiconductor integrated circuits and/or electronic elements that perform at least one or more of comparisons, determinations, calculations, and decisions to achieve programmed functions. For example, a processor may be a computer, a microprocessor, CPU, ASIC, an electronic circuitry (logic circuits), or a combination thereof.

Also, a computer readable recording medium (or memory) can include all sorts of data storage devices that store computer readable data. For example, a computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

These recording media may be electrically connected to the processor, and the processor may read data from and write data to the recording media. The recording media and the processor may be integrated with each other or physically separated from each other.

Hereinafter, a power supply method of a vehicle image recording apparatus based on redundancy power conversion, and a system for the same, according to an embodiment of the present disclosure will be described with reference to the accompanying drawings.

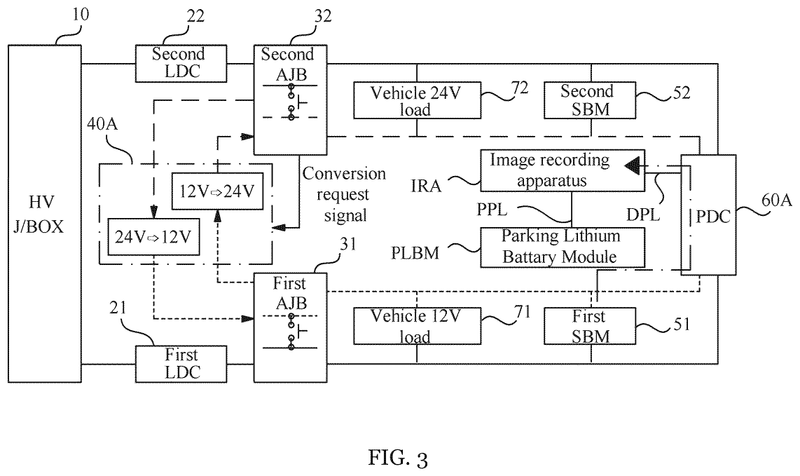

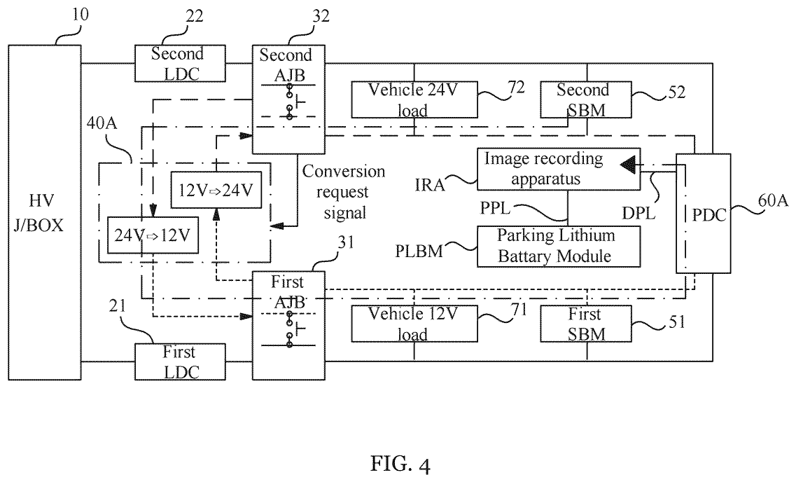

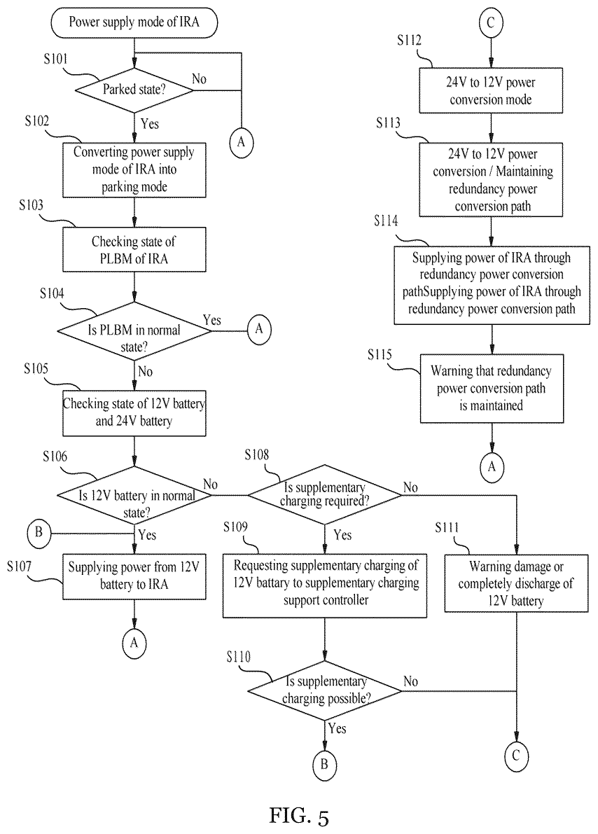

FIGS. 3 and 4 are views illustrating an example of a power transmission path in a power supply system of a vehicle image recording apparatus based on redundancy power conversion according to an embodiment of the present disclosure. FIG. 5 is a flowchart illustrating an example of a power supply process of the vehicle image recording apparatus based on the redundancy power conversion according to an embodiment of the present disclosure.

As illustrated in FIGS. 3 and 4, the power supply system of the vehicle image recording apparatus based on the redundancy power conversion according to an embodiment of the present disclosure can include: a high voltage junction box (HV J/BOX) 10 that can distribute a high voltage supplied from a main battery (not shown); a first low DC-DC converter (LDC) 21 that can convert the high voltage supplied from the HV J/BOX 10 into a first low voltage and output the converted first low voltage; a second LDC 22 that can convert the high voltage supplied from the HV J/BOX 10 into a second low voltage and output the converted second low voltage; a first active junction block (AJB) 31 that can include a built-in back to back switch (B2B), which can receive the first low voltage output from the first LDC 21 and can supply the received first low voltage to an electrical load connected to a rear end thereof; a second AJB 32 that can include a built-in B2B, which can receive the second low voltage output from the second LDC 22 and can supply the received second low voltage to an electrical load connected to a rear end thereof; a power-net domain controller (PDC) 60A that can supply power of the introduced first low voltage or second low voltage to the electrical load connected to the rear end; a first sub-battery module (SBM) 51 that can include a first low-voltage battery that can be charged by the first low voltage supplied from the first AJB 31 and can supply power to the PDC 60A and a first low voltage load 71 when discharged and a first intelligent battery sensor (IBS) that can detect a state of the first low-voltage battery; a second SBM 52 that can include a second low-voltage battery that can be charged by the second low voltage supplied from the second AJB 32 and can supply power to the PDC 60A and a second low voltage load 72 when discharged and a second IBS that can detect a state of the second low-voltage battery; a redundancy power converter (RPC) 40A that can convert a low voltage output from the first LDC 21 or the second LDC 22 into another low voltage having a different magnitude according to a power conversion request signal generated by the first AJB 31 or the second AJB 32 and can supply the converted low voltage to the first AJB 31 or the second AJB 32 that generates the power conversion request signal; an image recording apparatus (IRA) that can store an image obtained through at least one camera; and a park low battery module (PLBM) that can supply power for driving the IRA in a parked state, any combination of or all of which may be in plural or may include plural components thereof.

The PDC 60A can supply power for driving the IRA while a vehicle is driving, and check a state of the PLBM in the parked state. When the state of the PLBM is not in a normal state, the PDC 60A can check a state of the first low-voltage battery through the first IBS of the first SBM 51 and then, when the first low-voltage battery is in the normal state, supply discharge power of the first low-voltage battery as a driving power of the IRA as illustrated in FIG. 3.

Also, when the PDC 60A determines that the first low-voltage battery requires supplementary charging by checking the state of the first low-voltage battery through the first IBS of the first SBM 51, the PDC 60A can transmit a recharge request signal, and when the PDC 60A confirms that the supplementary charging may not be performed through a response to the recharge request signal, the PDC 60A can request the RPC 40A to form a path for supplementary charging the first low-voltage battery, and the RPC 40A can form a power conversion path from the second SBM 52 to the first SBM 51 for supplementary charging the first low-voltage battery as illustrated in FIG. 4.

While the supplementary charging of the first low-voltage battery is performed, power converted from the second SBM 52 to the first SBM 51 can be supplied as driving power of the IRA at the same time.

Hereinafter, the above-described processes will be described in more detail with reference to FIG. 5. In operation S101, it can be determined whether the vehicle is in the parked state. When it is determined that the vehicle is in the parked state, the operation S101 can proceed to operation S102, so that a power supply mode of the image recording apparatus can be switched to a parking mode.

That is, the IRA can receive driving power through a power supply line PL1 of the PDC 60A while the vehicle is driving and receive driving power through a power supply line PL2 of the PLBM while the vehicle is parked.

Thereafter, in operation S103, a state of the PLBM can be checked, and in operation S104, it can be determined whether the state of the PLBM is normal. That is, it can be determined whether the PLBM is damaged or fully discharged due to a long-term parking.

When it is determined in operation S104 that the PLBM is not in the normal state, the operation S104 can proceed to operation S105, so that states of 12V and 24V low voltage batteries disposed in the first SBM 51 and the second SBM 52 can be checked.

In operation S106, it can be determined whether the state of the 12V low-voltage battery is in the normal state. When the normal state is determined, the operation S106 can proceed to operation S107, so that the power of the image recording apparatus can be supplied to the 12V low-voltage battery as illustrated in FIG. 3.

On the other hand, when it is determined in operation S106 that the 12V low-voltage battery is not in the normal state, the operation S106 can proceed to operation S108 to determine whether the normal state is obtained by supplementary charging.

When it is determined in operation S108 that the normal state is obtained by supplementary charging, the operation S108 can proceed to operation S109, so that a recharge mode entering can be requested to a recharge support controller (not shown) such as BMS or VCU, and a response from the recharge support controller can be checked.

In operation S110, it can be checked whether a response that does not allow the recharge mode entering is applied based on a response signal from the recharge support controller requested in the operation S109. A condition for not allowing the recharge mode entering can include: a first case of all sorts of failures or non-responses of the recharge support controller; a second case in which a wireless update for a high-voltage control component is being performed; a third case in which a SOC of a high-voltage battery is less than 25% due to discharge of the high-voltage battery; a fourth case (maintenance window opened) in which a high voltage is not forcedly applied during maintenance; and a fifth case in which IG3 power for the recharge mode entering is not applied. The IG3 power mode can be a power mode in which power is applied to at least one controller related to charging by an external power source a high-voltage battery that supplies for the supplementary charging.

Thus, when it is determined that a current condition corresponds to one of the above-described five cases for not allowing the recharge mode entering described in the operation S110, the PDC 60A performs operation S112 to request, to the RPC 40A, a smoothing recharge according to redundancy power conversion of the 12V low-voltage battery.

The RPC 40A can perform the operation S112 in response to the request from PDC 60A to perform a redundancy mode that converts a discharge voltage of the 24V low-voltage battery in the second SBM 52 into a 12V voltage.

Thereafter, in operation S113, a recharge path as illustrated in FIG. 4 can be formed.

Through operation S114, while the supplementary charging of the first low-voltage battery is performed, power converted from the second SBM 52 to the first SBM 51 can be supplied as driving power of the IRA at the same time.

Thereafter, in operation S115, a warning can be issued to a vehicle owner or a previous driver that the redundancy power conversion path is being maintained.

An embodiment of the present disclosure can provide a power supply method of a vehicle image recording apparatus based on a redundancy power conversion, and the system for the same, to exhibit the effect of stably driving the vehicle image recording apparatus through a power supply based on the redundancy power conversion in the parking mode condition even under an environment in which a PLBM of the vehicle image recording apparatus has failed or is completely discharged.

Although the embodiments have been described with reference to a number of illustrative example embodiments thereof, it can be understood that numerous other modifications and embodiments can be devised by those skilled in the art that can fall within the spirit and scopes of the present disclosure. More particularly, various variations and modifications can be possible in the component parts and/or arrangements of the subject combination arrangement within the scopes of the present disclosure, the drawings, and the appended claims. In addition to variations and modifications in the component parts and/or arrangements, alternative uses also can be apparent to those skilled in the art.

What is claimed is:

1. A method for supplying power of an image recording apparatus for a vehicle, the method comprising:
determining that a battery module of the image recording apparatus (IRA) is in an abnormal state;
detecting a voltage state of a first low-voltage battery or a second low-voltage battery in response to determining that the battery module is in the abnormal state;
determining whether the first low-voltage battery is usable as a replacement for the battery module according to the detected voltage state; and
supplying power of the first low-voltage battery to the IRA in response to determining that the first low-voltage battery is usable as the replacement for the battery module.

2. The method of claim 1, further comprising converting power of the second low-voltage battery into a first low voltage to provide to the IRA in response to determining that the first low-voltage battery is not usable as the replacement for the battery module.

3. The method of claim 2, wherein the determining of whether the first low-voltage battery is usable as a replacement for the battery module comprises determining that the first low-voltage battery is not usable as the replacement in response to a charged state of the first low-voltage battery being below a preset threshold value, and the first low-voltage battery being situated in a case in which supplementary charging thereto is unavailable.

4. The method of claim 3, wherein the case in which the supplementary charging is unavailable comprises a state in which the supplementary charging for the first low-voltage battery is unavailable due to a failure or a non-response of a controller related to the supplementary charging.

5. The method of claim 3, wherein the case in which the supplementary charging is unavailable comprises a state in which the supplementary charging for the first low-voltage battery is unavailable because a wireless update on a control component of a high-voltage battery supplying power for the supplementary charging is in progress.

6. The method of claim 3, wherein the case in which the supplementary charging is unavailable comprises a state in which the supplementary charging for the first low-voltage battery is unavailable due to a condition in which a state of charge (SOC) of a high-voltage battery supplying power for the supplementary charging is equal to or less than a threshold level.

7. The method of claim 3, wherein the case in which the supplementary charging is unavailable comprises a state in which the supplementary charging is unavailable because a maintenance operation is in progress.

8. The method of claim 3, wherein the case in which the supplementary charging is unavailable comprises a state in which the supplementary charging is unavailable due to a condition in which an accessory power mode is not applied in the vehicle, wherein for the accessory power mode, power is applied to at least one controller related to charging by an external power source of a high-voltage battery supplying the supplementary charging.

9. The method of claim 1, wherein the first low-voltage battery comprises a 12V battery.

10. The method of claim 1, wherein the second low-voltage battery comprises a 24V battery.

11. A power supply system of an image recording apparatus (IRA) for a vehicle, the power supply system comprising:
a first low DC-DC converter (LDC) configured to convert a high voltage of a main battery into a first low voltage;
a second LDC configured to convert the high voltage of the main battery into a second low voltage;
a first active junction block (AJB) comprising a first built-in back-to-back switch (B2B), which is configured to receive a first low voltage output from the first LDC and supply the first low voltage to a first electrical load operating with the first low voltage;
a second AJB comprising a second built-in B2B, which is configured to receive a second low voltage output from the second LDC and supply the second low voltage to a second electrical load operating with the second low voltage;
a first sub-battery module (SBM) comprising a first low-voltage battery that is configured to be charged by the first low voltage supplied from the first AJB and supply power to the first electric load and a first intelligent battery sensor (IBS), wherein the first IBS is configured to detect a state of the first low-voltage battery;
a second SBM comprising a second low-voltage battery that is configured to be charged by the second low voltage supplied from the second AJB and supply power to the second electric load and a second IBS, wherein the second IBS is configured to detect a state of the second low-voltage battery;
a redundancy power converter (RPC) configured to convert power between the first low voltage and the second low voltage according to a power conversion request signal generated by the first AJB or the second AJB;
a battery module configured to supply power to the IRA in a parked state of the vehicle; and
a controller comprising one or more processors and a non-transitory memory storing computer-readable instructions that, when executed by the one or more processors, enable the one or more processors to control power supply to the IRA, wherein the power supply is supplied to the IRA by:
checking a state of the battery module in the parked state,
checking a state of the first low-voltage battery through the first IBS in response to the state of the battery module being not in a normal state, and
controlling power supply of the first low-voltage battery to the IRA in response to the first low-voltage battery being in the normal state.

12. The system of claim 11, wherein the instructions further enable the one or more processors to:
transmit a supplementary charging request signal in response to determining that supplementary charging is required based on the check of the state of the first low-voltage battery through the first IBS; and
request a formation of a power conversion path for the supplementary charging of the first low-voltage battery to the RPC in response to a condition that the supplementary charging is unavailable being checked in response to the supplementary charging request signal, such that
the RPC forms the power conversion path from the second SBM to the first SBM for the supplementary charging of the first low-voltage battery.

13. The system of claim 12, wherein the condition that the supplementary charging is unavailable comprises a state in which the supplementary charging is unavailable due to a condition of a failure or a non-response of a control component related to the supplementary charging.

14. The system of claim 12, wherein the condition that the supplementary charging is unavailable comprises a state in which the supplementary charging is unavailable due to a condition in which a wireless update on a control component of the main battery is in progress.

15. The system of claim 12, wherein the condition that the supplementary charging is unavailable comprises a state in which the supplementary charging is unavailable due to a condition in which a state of charge (SOC) of the main battery is equal to or less than a threshold level.

16. The system of claim 12, wherein the condition that the supplementary charging is unavailable comprises a state in which the supplementary charging is unavailable due to a condition in which a maintenance operation is in progress.

17. The system of claim 12, wherein the condition that the supplementary charging is unavailable comprises a state in which the supplementary charging is unavailable due to a condition in which an accessory power mode is not applied in the vehicle, wherein for the accessory power mode, power is applied to at least one control component related to charging by an external power source of a high-voltage battery supplying the supplementary charging.

18. The system of claim 11, wherein each of the battery module and the first low-voltage battery comprises a 12V battery.

19. The system of claim 11, wherein the second low-voltage battery comprises a 24V battery.

20. A method for supplying power of an image recording apparatus for a vehicle, the method comprising:
determining that a battery module of the image recording apparatus (IRA) is in an abnormal state;
detecting a voltage state of a first low-voltage battery in response to determining that the battery module is in the abnormal state;
determining whether the first low-voltage battery is usable as a replacement for the battery module based on the detected voltage state;
supplying power of the first low-voltage battery to the IRA in response to determining that the first low-voltage battery is usable as the replacement for the battery module; and
converting power of a second low-voltage battery into a first low voltage to provide to the IRA in response to determining that the first low-voltage battery is not usable as the replacement for the battery module, wherein the first low-voltage battery and the second low-voltage battery are rated for different voltage level usage.
